(19) United States
(12) Patent Application Publication
(10) Pub. No.: US 2007/0045187 A1
(43) Pub. Date: Mar. 1, 2007

(54) Biofouling control of membrane water-purification systems

(76) Inventors: James Rulon Young Rawson, Clifton Park, NY (US); Raul Eduardo Ayala, Clifton Park, NY (US); Richard Ambrose Royer, Ballston Lake, NY (US)

Correspondence Address: Patrick S. Yoder;FLETCHER YODER, P.O. Box 692289, Houston, TX, 77269-2289, US

(21) Appl. No.: 11/218,991

(22) Filed: Sep. 1, 2005

(51) Int. Cl. B01D 61/00

(52) U.S. Cl. 210/639; 210/650; 210/195.2; 210/259; 210/805; 210/806

(57) ABSTRACT

A water-purification system is provided. The water-purification system includes a bacteriostatic filter including a bacteriostatic agent therein and a membrane filter fluidically coupled downstream of the bacteriostatic filter and configured to block the passage of cations and anions therethrough.

### BACKGROUND

The present technique relates generally to water-purification systems and methods, and, in certain exemplary embodiments, to techniques for reducing biofouling of a membrane in a membrane-based water-purification system, for example.

Various types of water-purification systems are known and in use. In general, a membrane water-purification system serves to remove all ions in water, decreasing the likelihood of the formation of scaling that often manifests itself as an unattractive film around sinks and dishes, for instance. As an example of a traditional technique, employing a reverse osmosis membrane separates ions and minerals from water received at high pressure, thus reducing the presence of scaling. Another traditional technique employs nanofiltration membranes to purify water for residential use and is generally located at a “point of entry” or a “point of use” of the residence. Nanofiltration membranes typically include a semi-permeable membrane that relies on surface charges to selectively reject divalent and polyvalent ions (i.e. hardness ions) while allowing passage of monovalent ions, thus, again, reducing the presence of scaling in the water supply.

Unfortunately, these membrane separation processes are prone to fouling by microbes. For example, microbes, over time, accumulate on the membrane (often referred to as “biofouling”), and this biofouling causes a decrease in permeate effluent and an increase in pressure differential, both of which are generally undesirable. In addition, continued operation of a water-purification system in such conditions generally requires an increased number of cleanings over the lifetime of the membrane, thereby decreasing the membrane life and increasing maintenance costs, for instance. Typically, performance of membrane-based water purifiers is reduced by membrane biofouling. Further, the performance of the membrane is also degraded by the presence of chlorine and chloramines in the influent water. Therefore, it is advantageous to remove the chlorine or chloramines from the influent water prior to treating the water with the membrane-based systems. It is also advantageous to remove chlorine and chloramines from the influent water to improve the potable quality of the water.

In some conventional membrane systems, activated carbon filters, hereafter carbon filters, are disposed upstream of the membrane to remove chlorine and chloramines from the influent water. Unfortunately, use of activated carbon filters results in growth of bacteria on the surface of the carbon filter. In summary, chlorine and chloramines prevent the growth of microbes and bacteria, and filtering out chlorine and chloramines leaves the water supply downstream of the carbon filter and upstream of the membrane susceptible to bacterial growth. Further, bacterial build-up is sloughed off from the activated carbon and is released into the effluent water from the filter. As a result, the concentration of bacteria in the effluent water may exceed the concentration of bacteria in the influent water. The high levels of bacteria in the effluent water accelerates the biofouling of any membrane used downstream of the carbon filter.

Therefore, there is a need for an improved membrane-based water-purification technique. Particularly, there is a need for an improved technique for reducing biofouling of a membrane of a membrane-based water-purification system.

### BRIEF DESCRIPTION

In accordance with one exemplary embodiment, the present technique provides a water-purification system. The water-purification system includes a bacteriostatic filter including a bacteriostatic agent therein and a membrane filter fluidically coupled downstream of the bacteriostatic filter and configured to block the passage of cations and anions therethrough.

In accordance with another exemplary embodiment, the present technique provides a method for purifying water. The method includes receiving an influent flow of water and routing the influent flow of water through a filter having a bacteriostatic agent to produce a first effluent flow of water having a concentration of bacteria not greater than that of the influent flow of water. The method also includes routing the first effluent flow of water through a membrane filter to produce a second effluent flow of water comprising purified water by rejecting cations and anions in the first effluent flow of water.

### DRAWINGS

These and other features, aspects, and advantages of the present invention will become better understood when the following detailed description is read with reference to the accompanying drawings in which like characters represent like parts throughout the drawings, wherein:

FIG. 1 is a diagrammatical representation of an exemplary water-purification system, in accordance with an embodiment of the present technique;

FIG. 2 is a schematic diagram depicting flow of water through the water-purification system of FIG. 1, in accordance with an exemplary embodiment of the present technique;

FIG. 3 is a graphical representation of an exemplary distribution of a concentration of a bacteriostatic agent employed in the water-purification system of FIG. 1, in accordance with an exemplary embodiment of the present technique;

FIG. 4 is a graphical representation of bacterial concentration results of permeate water and concentrate for a test performed with and without the use of the bacteriostatic agent, in accordance with an exemplary embodiment of the present technique;

FIG. 5 is a graphical representation of the water permeability results performed on the membrane employed in the water-purification system of FIG. 1 without the use of the bacteriostatic agent, in accordance with an exemplary embodiment of the present technique; and

FIG. 6 is a graphical representation of the water permeability through the membrane employed in the water-purification system of FIG. 1 with the use of the bacteriostatic agent, in accordance with an exemplary embodiment of the present technique.

### DETAILED DESCRIPTION

As discussed in detail below, embodiments of the present invention function to provide techniques for reducing biofouling of a membrane-based water purification system. It should be noted that, the term “biofouling,” as used herein, refers to the accumulation and growth of bacteria on a surface, such as those of a membrane or a carbon filter, for example. Although the present discussion focuses on point of entry (POE) and point of use (POU) membrane-based water purification systems, the present technique is applicable to any membrane-based water purification systems for use in facilities that utilize or produce potable water or that desire to reduce the concentration of bacteria in the effluent water supply of a filter upstream of the membrane filter. Accordingly, the appended claims should not be limited to or by the exemplary embodiments provided in the following discussion.

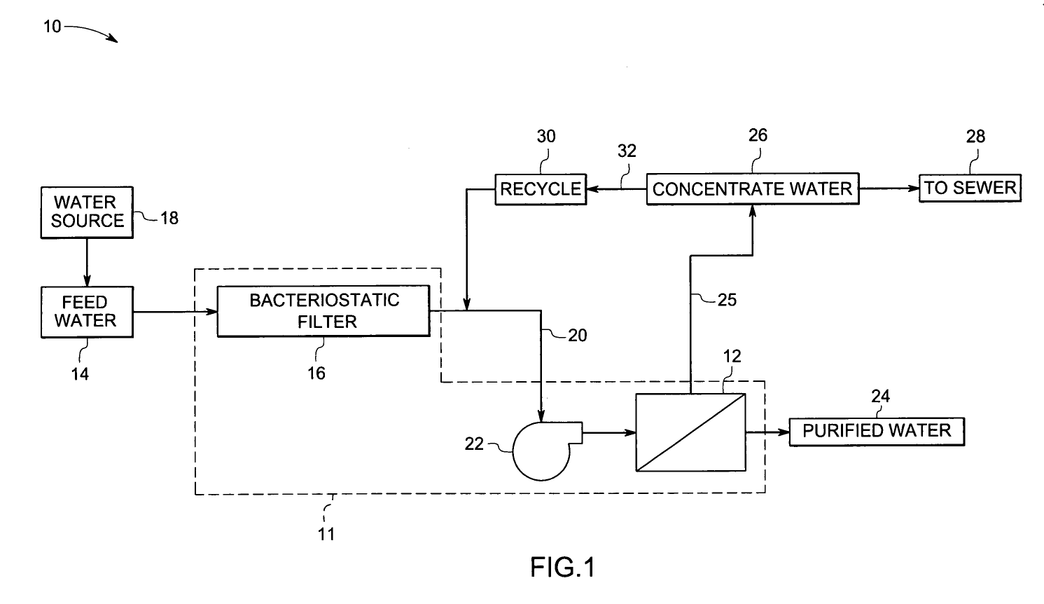

Referring now to the drawings, FIG. 1 illustrates an exemplary water-purification arrangement 10. The arrangement 10 has a water-purification system 11 that includes a water-purification membrane 12 configured to purify an influent flow of water such as feed water 14 by rejecting cations and anions ordinarily present therein. In one embodiment, the water-purification membrane 12 is configured to remove about 95% of the cations and anions in the influent flow of feed water 14, for example. Further, by preventing hardness ions, which include divalent ions, such as calcium and magnesium from entering the effluent supply, the likelihood of unattractive and undesirable scaling build-up is reduced. Such a system 11 is particularly useful for improving potable water. That is, the exemplary system 11 is particularly helpful in purifying the water received from a water source 18, including a municipal water supply, and provided to a local structure, such as a private residence or commercial establishment. Thus, the exemplary system 11 may be particularly useful as a point of entry (POE) system.

In one embodiment, the water-purification membrane 12 is a nanofiltration membrane. As an alternative, the water-purification membrane 12 can be a reverse osmosis membrane. Of course, the particular kind of water purification membrane 12 employed by the water-purification system 11 depends upon the desired operating parameters and conditions, and the present technique is applicable to any number of membrane types.

The exemplary water-purification system 11 also includes a bacteriostatic filter 16 disposed upstream of the water-purification membrane 12. As used herein, the bacteriostatic filter 16 contains a bacteriostatic agent to prevent growth of bacteria in the filter 16, which would subsequently be discharged in high concentrations in the filter's effluent. Further, discharge of high concentrations of bacteria in the effluent would cause biofouling of the membrane filter 12. In one embodiment, the filter 16 contains activated carbon, which acts to remove chlorine from the feed water 14. Removal of the chorine, however, leaves the egressing water from the filter 16 susceptible to bacterial growth. In this embodiment, the filter 16 includes a bacteriostatic agent to retard the growth of bacteria both on filter surfaces and downstream of the filter 16. As used herein the term “bacteriostatic” agent refers to an agent configured to inhibit the growth and increase in numbers of bacteria within the water-purification system 11. The bacteriostatic agent inhibits the growth of bacteria in the filter 16 upstream of the membrane filter 12 and, in turn, reduces biofouling of the water-purification membrane 12.

In one embodiment, the exemplary filter 16 is activated carbon filter, and employs silver as the impregnated bacteriostatic agent. In certain embodiments, the concentration of the bacteriostatic silver in the filter 16 ranges from about 0.1 weight % to about 1 weight %. Of course other kinds of filters with various kinds of bacteriostatic agents are envisaged. It should be noted that any biocidal agent may also be used to achieve the same bacteriostatic properties, provided it is used in sufficiently low concentrations and it has been demonstrated to be safe for use in drinking water. Further, the concentration of the bacteriostatic agent in the filter 16 may be varied depending upon the operating conditions of the water-purification system 11 for substantially reducing the biofouling of the water-purification membrane 12.

During operation, the filter 16 receives the flow of feed water 14 having a first concentration of bacteria from the water source 18, such as a source of water, including a municipal water supply, for example. Once the feed water 14 is processed, the filter 16 discharges a first effluent flow of water 20 having a second concentration of bacteria that is not greater than the first concentration of bacteria in the influent flow of water 14. That is, the filter 16 precludes the concentration of bacteria in the first effluent flow of water 20 from exceeding the concentration of bacteria in the influent flow of feed water 14.

The silver in the filter 16 functions as the bacteriostatic agent to prevent the growth of bacteria in the filter 16. In operation, silver from the filter 16 binds to sulfhydryl groups of proteins of the bacteria and renders the proteins inactive, thereby preventing the growth of bacteria. By reducing bacterial growth in the filter 16, biofouling of the water-purification membrane 12 is also reduced.

Moreover, the water-purification system 11 may include a pump 22 located fluidically between the filter 16 and the water-purification membrane 12, to boost the pressure of the first effluent flow of water 20 to the water-purification membrane 12. As will be appreciated by those skilled in the art, the amount of pressure boost can vary, based on whether the water source 18 is a pressurized municipal supply, groundwater or well water, for example. Typically, the pump 22 will boost the water pressure to a determined performance level for the water-purification membrane 12.

In the present embodiment, the water-purification membrane 12 rejects the cations and anions in the first effluent flow 20 and discharges a flow of purified water 24. Subsequently, the purified water 24 may be supplied to one or more points of use such as a faucet or other point of use device (e.g., a refrigerator), for example. In addition, the retained uncharged component, divalent and multivalent ions are removed from the water-purification membrane 12 as membrane reject stream 25. The membrane reject stream 25 includes concentrate water 26 that may be subsequently discarded or recycled. For example, the concentrate water 26 may be discarded, such as through discharge into a sewer 28, or used for purposes in which hardness ions are not problematic. In a present embodiment, the bacteriostatic agent discharged from the filter 16 is blocked from passing through the water-purification membrane 12 into the flow of purified water 24 and is instead recycled back through the water-purification membrane 12 via the membrane reject stream 25 and recycle loop 30. More specifically, the bacteriostatic agent rejected into the concentrate water 26 is routed upstream toward the filter 16 via a feedback conduit 32 for further reducing the biofouling of the water-purification membrane 12. It should be noted that various configurations may be envisaged to achieve the recycling of the concentrate water 26 through the water-purification membrane 12. The components required for such recycling operation, such as check valves and conduits, are not presently discussed in detail for the ease of explanation. In certain embodiments, the recycled water can pass through the water-purification membrane 12 to increase water recovery of the water-purification system 11.

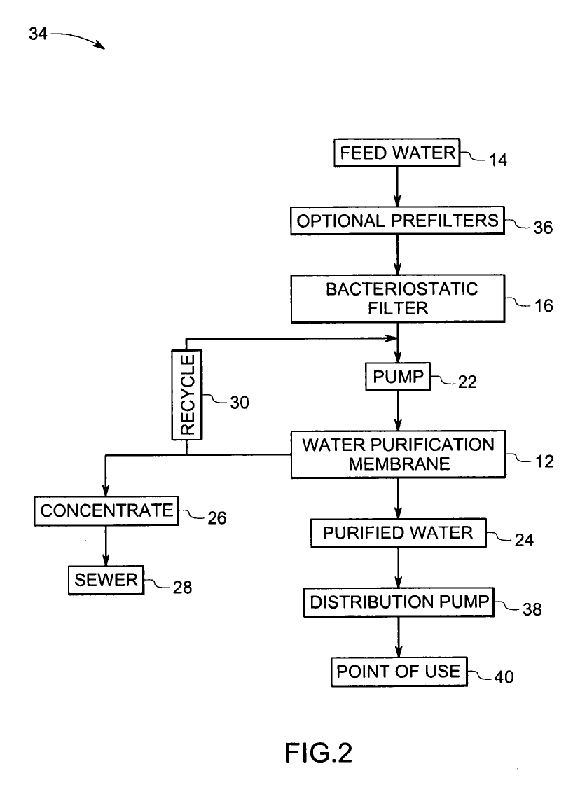

FIG. 2 is a schematic diagram depicting flow of water 34 through the water-purification system 11 of FIG. 1. As illustrated, the water-purification system 11 receives feed water 14 from a water source for purification through the water-purification membrane 12. In certain embodiments, the feed water may be filtered through a prefilter 36 in order to improve the performance and longevity of the water-purification membrane 12. In the illustrated embodiment, the prefilter 36 is disposed upstream of the bacteriostatic filter 16. In certain embodiments, the prefilter 36 may be disposed between the bacteriostatic filter 16 and the water-purification membrane 12. In one embodiment, a prefilter can be employed to remove large suspended material that would otherwise clog the water-purification membrane 12. Other prefilters suitable for use include iron prefilters to remove iron from influent flow of water, sediment prefilters to remove sediment from the feed water and biological prefilters to remove bacteria, protozoa and other microorganisms. In certain other embodiments, the feed water 14 may be pretreated to improve performance of the water-purification system 11 by either heating the water sufficiently to improve flow rates without causing scaling. Other pretreatment steps, such as chemical pretreatment may be performed with implementation of the present technique.

The effluent flow of water from the prefilter 36 is then supplied to the bacteriostatic filter 16. In a present embodiment, the bacteriostatic filter includes a silver impregnated carbon filter. As discussed above, the influent flow of feed water 14 to the bacteriostatic filter 16 may include bacteria or other microorganisms in the influent flow of feed water 14 such as those originating from the water source 18. For example, in this embodiment, the influent flow of feed water 14 to the filter 16 includes a first concentration of bacteria from the water source 18. The bacteriostatic filter 16 receives the influent flow of feed water 14 and discharges a first effluent flow of water having a second concentration of bacteria in the first effluent flow of water. In one embodiment, the bacteriostatic filter 16 operates such that the second concentration of bacteria in the first effluent flow of water is not greater than the first concentration of bacteria in the influent flow thereby reducing the biofouling of the water-purification membrane.

The first effluent flow of water from the bacteriostatic filter 16 is then directed to the water-purification membrane 12. Further, the pump 22 may be employed to boost the pressure of first effluent flow to the water-purification membrane 12. During operation, the pressurized flow of water from the pump 22 is purified by the water-purification membrane 12 to generate the flow of purified water 24 by rejecting the cations and anions in the water. In certain embodiments, a distribution pump 38 may be employed to deliver the purified water 24 to a point of use 40 at a desired pressure. In one embodiment, the purified water 24 from the water-purification membrane 12 is supplied to a residential application.

Moreover, the water-purification membrane 12 also discharges the effluent flow of concentrate 26 that may be subsequently discarded, such as through discharge into the sewer 28. In one embodiment, a portion of the concentrate water 26 may be recycled back through the water-purification membrane 12 as illustrated by the recycle loop 30. Particularly, at least a portion of the bacteriostatic agent blocked by the water-purification membrane 12 is routed upstream, toward the filter 16 for use in further reducing biofouling of the water-purification membrane 12. Advantageously, the partial recirculation of the concentrate 26 facilitates the reduction of biofouling of the water-purification membrane 12 by augmenting the existing concentration of the bacteriostatic agent in the influent water to the water-purification membrane 12.

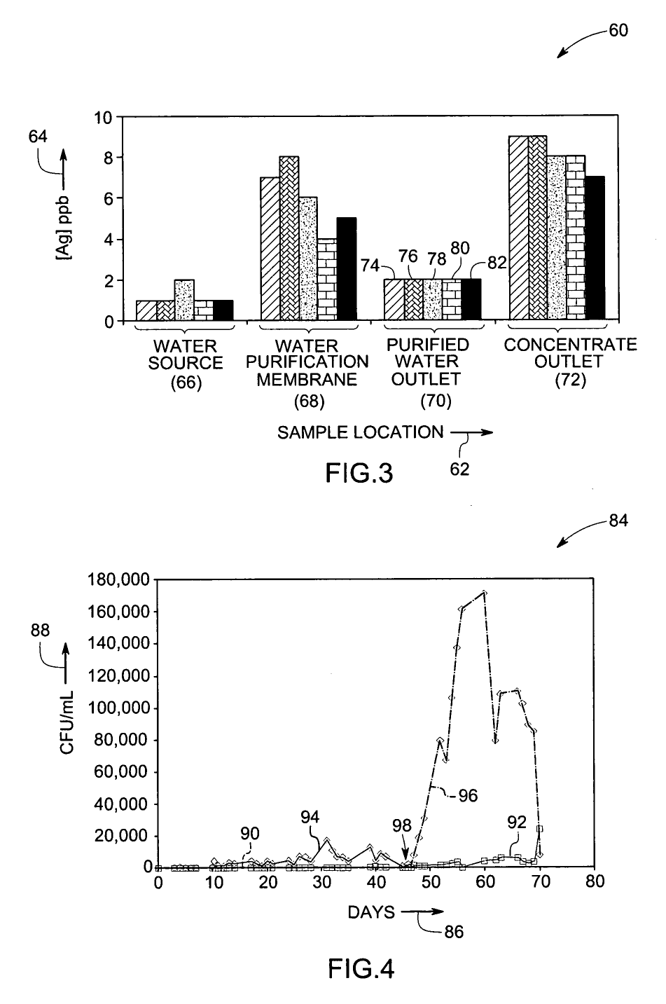

FIG. 3 is a graphical representation of an exemplary distribution 60 of the concentration of the bacteriostatic agent employed in the filter 16 of the water-purification system 11 of FIG. 1, in accordance with an exemplary embodiment of the present technique. As illustrated, the abscissa axis represents exemplary locations 62 where the concentration of the bacteriostatic agent is measured and the ordinate axis represents the measured concentration 64 of the bacteriostatic agent at the exemplary locations. The concentration of the bacteriostatic agent at each of these locations is measured as parts per billion (ppb). In this embodiment, the bacteriostatic agent includes silver. The concentration of the bacteriostatic agent is measured over a period of time at each of the referenced locations 62. The exemplary locations for measurements include water source outlet 66 for the water source 18, membrane inlet 68 of the water-purification membrane 12, purified water and concentrate outlets 70 and 72 for the purified water 24 and the concentrate 26 respectively from the water-purification system 11. In this embodiment, the concentration of the bacteriostatic agent at each of these locations is measured during five consecutive weeks as represented by reference numerals 74, 76, 78, 80 and 82.

As illustrated in FIG. 3, the distribution of the concentration of the silver at the water source outlet 66 maintains a substantially steady state over the five weeks. However, in certain embodiments the concentration of silver may change over a time period depending upon the quality of water from the water source. For example, in the illustrated embodiment, the concentration of silver increases during the third week of operation. At the membrane inlet location 68, the concentration of silver is substantially higher than the concentration of silver at the water source outlet 66 due to filtration of the water supply through the silver impregnated carbon filter 16 prior to purification through the water-purification membrane 12. As noted above, slow release of silver from within the filter 16 provides ionic silver to prevent the growth of bacteria in the filter 16. Further, as illustrated, the concentration of the silver at the membrane inlet location 68 may increase during the periods of operation of the water-purification system 11 such as due to recirculation of silver from the concentrate to upstream of the membrane 12 that will be discussed below. For example, in the illustrated embodiment, the concentration of silver at the membrane inlet 68 increases to about 8 ppb during the second week of operation as compared to 1 ppb concentration of silver at the water source 66 during the same week. This increase in the concentration of silver is due to the recycling of silver from the concentrate 26.

Moreover, the concentration of silver at the purified water outlet 70 maintains a desired concentration of silver over a period of time to achieve pre-determined quality standards of the purified water for use in an application such as a point-of-entry residential application. In fact, as illustrated in FIG. 3, the concentration of silver at the concentrate outlet 72 remains nearly constant.

As noted above, the use of a bacteriostatic agent such as silver in the filter 16 precludes the concentration of bacteria in the effluent water from substantially exceeding the concentration of bacteria in the influent water. In particular, the silver impregnated carbon filter 16 disposed upstream of the water-purification membrane 12 prevents the increase in bacterial concentration in the effluent flow of water from the carbon filter 16. FIG. 4 is a graphical representation of bacterial concentration results 84 in the purified water 24 and the concentrate 26 for a test performed with and without the use of the bacteriostatic agent in the water-purification system 11. As illustrated, the abscissa axis represents the time period 86 of operation of the water-purification system 11. Further, the ordinate axis represents the bacterial concentration 88 over the period of time in the purified water 24 and concentrate 26 from the water-purification system 11. The bacterial concentration 88 is measured as colony forming units per milliliter of water (CFU/mL) that is indicative of the number of viable bacteria present in the water.

In the illustrated embodiment, the bacteria present in the purified water 24 and concentrate 26 from the water-purification membrane 12 are enumerated through the spread plate technique by employing R2A Agar as the medium. As will be appreciated by one skilled in the art, R2A Agar is a medium with a low nutrient content, which, in combination with a low incubation temperature and an extended incubation time, is suitable for the recovery of bacteria from water. In the present embodiment, R2A agar plates are inoculated and subsequently incubated in the dark for about 6 days to about 8 days at room temperature prior to counting colonies of bacteria. Further, each colony counted is considered to have originated from one bacterial cell present in the original samples of water. In certain embodiments, the samples of water may be diluted to achieve plates with an appropriate colony density of bacteria.

In the illustrated embodiment, the distribution of the bacterial concentration for the purified water 24 with and without the use of the bacteriostatic agent is represented by reference numerals 90 and 92 respectively. Similarly, the distribution of the bacterial concentration for the concentrate 26 with and without the use of the bacteriostatic agent is represented by reference numerals 94 and 96 respectively. In the illustrated embodiment, to evaluate the effect of use of the bacteriostatic agent such as silver in the filter 16 on the bacterial concentration in water, the silver impregnated carbon filter 16 is replaced with a standard activated carbon filter as represented by reference numeral 98 after a predetermined time period. As illustrated, the concentration of bacteria 90 in the purified water with the use of the bacteriostatic agent is negligible. Further, once the silver impregnated carbon filter 16 is replaced with a standard activated carbon filter, the concentration of bacteria 92 in the purified water 24 increases over a period of time. Similarly, the bacterial concentration in the concentrate 26 with the use of the bacteriostatic agent is substantially lesser than the bacterial concentration in the concentrate 26 without the use of the bacteriostatic agent as represented by curves 94 and 96.

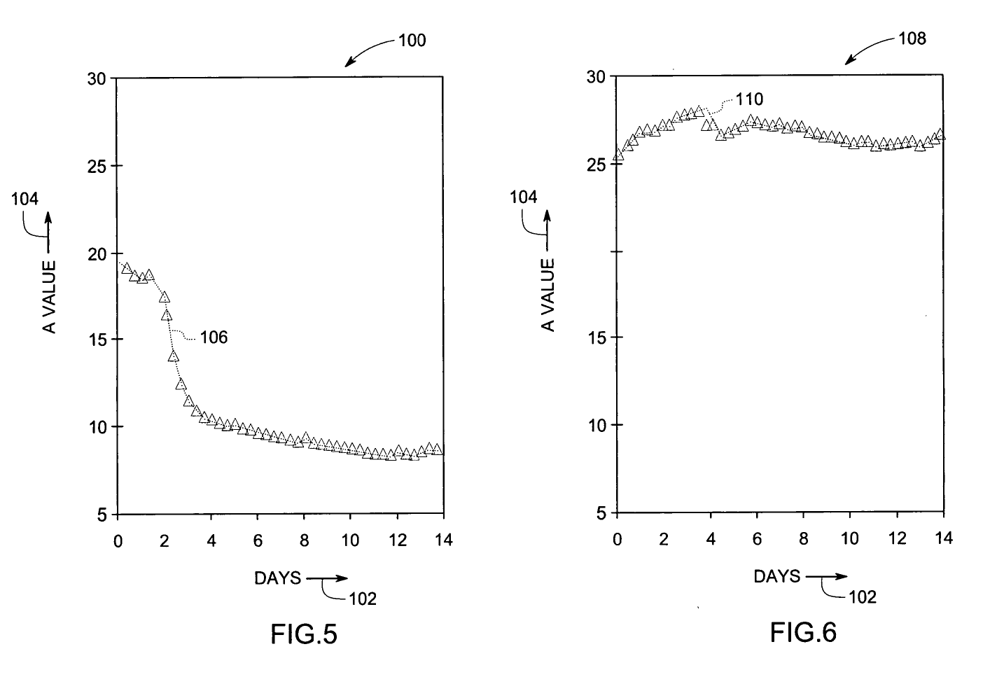

As noted above, the use of silver impregnated carbon filter 16 upstream of the water-purification membrane 12 minimizes the biofouling of the water-purification membrane 12. As a result, a pressure drop across the water-purification membrane 12 due to biofouling of the membrane 12 is substantially reduced, thereby preventing decreased flow rate through the water-purification membrane 12. FIGS. 5 and 6 show the water permeability in terms of the A value through the membrane 12 employed in the water-purification system 11 of FIG. 1 without and with the use of the bacteriostatic agent in the filter 16. As used herein, the “A value” is proportional to the water permeability of the membrane 12 that is represented by the ratio of cubic centimeters per second of purified water over the square centimeters of membrane area times the pressure measured in atmospheres.

Referring now to FIG. 5, the water permeability results 100 performed on the membrane 12 employed in the water-purification system 11 of FIG. 1 without the use of the bacteriostatic agent are represented. As illustrated, the abscissa axis 102 represents the period of operation of the water-purification system 11 and the ordinate axis 104 represents A value of the water-purification membrane 12. In the illustrated embodiment, the A value for the water-purification membrane 12 decreases over the time period as represented by exemplary distribution 106. The decrease of the water permeability of the water-purification membrane 12 is due to the biofouling of the membrane 12 due to accumulation of microbes on the water-purification membrane 12 over time.

FIG. 6 represents the water permeability results 108 performed on the membrane 12 employed in the water-purification system 11 of FIG. 1 with the use of the bacteriostatic agent in the filter 16 upstream of the water-purification membrane 12. In this embodiment, a silver impregnated carbon filter 16 is located upstream of the water-purification membrane 12. Again, the water permeability of the water-purification membrane 12 is measured in terms of the A value for the membrane 12. The A value of the membrane 12 with the bacteriostatic agent such as silver in the filter 16 upstream of the membrane 12 increases over a period of time and maintains a steady state over the time period as represented by the exemplary distribution 110. Further, the A value of the membrane 12 with the use of bacteriostatic agent in the filter is substantially greater than the A value of the membrane 12 without the use of the bacteriostatic agent. Thus, the use of bacteriostatic agent in the filter 16 upstream of the water-purification membrane 12 reduces the biofouling of the membrane 12 thereby enhancing the efficiency of the water-purification system 11.

The various aspects of the technique described hereinabove have utility in water-purification systems such as membrane-based water-purification systems. As will be appreciated by those skilled in the art, the present technique provides a mechanism of reducing biofouling of a membrane of the membrane-based water-purification system, while maintaining the desired quality of water from the water-purification system.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A water-purification system, comprising:
a bacteriostatic filter including a bacteriostatic agent therein; and
a membrane filter fluidically coupled downstream of the bacteriostatic filter and configured to block the passage of cations and anions therethrough.

2. The water-purification system as recited in claim 1, wherein the membrane filter is configured to block passage of the bacteriostatic agent released from the bacteriostatic filter therethrough.

3. The water-purification system as recited in claim 2, further comprising a feedback conduit configured to recycle the bacteriostatic agent rejected from the membrane filter upstream, to an effluent from the bacteriostatic filter, or an influent of the membrane filter.

4. The water-purification system as recited in claim 1, further comprising a pump located fluidically between the bacteriostatic and membrane filters.

5. The water-purification system as recited in claim 1, wherein the bacteriostatic filter comprises an activated carbon filter and the bacteriostatic agent comprises silver.

6. A water-purification system, comprising:
a filter configured to receive an influent flow of water and to discharge a first effluent flow of water, wherein the filter includes a bacteriostatic agent to limit the growth of bacteria in the filter such that the concentration of bacteria in the first effluent flow of water does not exceed the concentration of bacteria in the influent flow of water; and
a water-purification membrane disposed downstream of the filter, wherein the water-purification membrane is configured to receive the first effluent flow of water from the filter and to purify the first effluent flow of water by rejecting cations and anions present in the first effluent flow of water, and to discharge purified water as a second effluent flow of water.

7. The water-purification system as recited in claim 6, wherein the bacteriostatic agent comprises silver.

8. The water-purification system as recited in claim 7, wherein a concentration of the silver bacteriostatic agent in the filter ranges from about 0.1 to 1.0 weight percent.

9. The water-purification system as recited in claim 6, wherein the water-purification membrane comprises a nanofiltration membrane or a reverse osmosis membrane.

10. The water-purification system as recited in claim 6, further comprising a pump disposed downstream of the filter to increase pressure of the first effluent flow of water received by the water-purification membrane.

11. The water-purification system as recited in claim 6, wherein the water-purification membrane is configured to discharge a flow of concentrate including rejected amounts of the bacteriostatic agent, and wherein the bacteriostatic agent rejected by the water-purification membrane in the concentrate is recycled upstream to the first effluent flow of water.

12. A water-purification system, comprising:
a bacteriostatic filter including a bacteriostatic agent therethrough;
a membrane filter configured to block the passage of cations and anions therethrough, and located downstream of the bacteriostatic filter, wherein the membrane filter is further configured to block passage of the bacteriostatic agent therethrough; and
a feedback conduit fluidically coupled to the bacteriostatic filter and to the membrane filter, wherein the feedback conduit is configured to route the bacteriostatic agent upstream to an influent of the membrane filter, or an effluent of the bacteriostatic filter to increase a concentration of the bacteriostatic agent in the influent of the membrane filter.

13. The water-purification system as recited in claim 12, wherein the bacteriostatic filter comprises an activated carbon filter and the bacteriostatic agent comprises silver.

14. The water-purification system as recited in claim 12, wherein the water-purification system is configured for use in a point-of-entry, or a point-of-use residential application.

15. The water-purification system as recited in claim 12, wherein a concentration of the bacteriostatic agent in the effluent flow of water from the bacteriostatic filter and from a recycled portion of water from the membrane filter is configured to substantially reduce biofouling of the membrane filter.

16. The water-purification system as recited in claim 12, wherein the membrane filter comprises a nanofiltration membrane or a reverse osmosis membrane.

17. A method for purifying water, comprising:
receiving an influent flow of water;
routing the influent flow of water through a filter having a bacteriostatic agent to produce a first effluent flow of water having a concentration of bacteria not greater than that of the influent flow of water; and
routing the first effluent flow of water through a membrane filter to produce a second effluent flow of water comprising purified water by rejecting cations and anions in the first effluent flow of water.

18. The method as recited in claim 17, further comprising rejecting the bacteriostatic agent from passing through the membrane filter into the second effluent flow of water and routing the rejected bacteriostatic agent into a flow of concentrate discharged from the membrane filter.

19. The method as recited in claim 18, further comprising recycling the bacteriostatic agent rejected from the membrane filter upstream, to the first effluent flow of water to reduce the biofouling of the membrane filter.
